(19) United States
(12) Patent Application Publication
(10) Pub. No.: US 2005/0286674 A1
(43) Pub. Date: Dec. 29, 2005

(54) Composite-wall radiation-shielded cask and method of assembly

(75) Inventors: Larry E. Fischer, Los Gatos, CA (US); Gerald C. Mok, Morgan Hill, CA (US)

Correspondence Address: James S. Tak;Assistant Laboratory Counsel, Lawrence Livermore National Laboratory, P.O. Box 808, L-703, Livermore, CA, 94551, US

(73) Assignee: The Regents of the University of California

(21) Appl. No.: 10/881,999

(22) Filed: Jun. 29, 2004

(51) Int. Cl. G21C 19/00

(52) U.S. Cl. 376/272

(57) ABSTRACT

A composite-wall radiation-shielded cask and method of assembly having an inner shell surrounding a containment volume, and two or more non-annular sections of a radiation-shielding material secured with a fastener or strap to the inner shell to form a bound inner assembly. The bound inner assembly is inserted into an outer shell to form a clearance gap between the inner assembly and the outer shell. And the clearance gap is then filled with filler material capable of transferring mechanical and thermal loads between the bound inner assembly and the outer shell.

The United States Government has rights in this invention pursuant to Contract No. W-7405-ENG-48 between the United States Department of Energy and the University of California for the operation of Lawrence Livermore National Laboratory.

### I. FIELD OF THE INVENTION

This invention relates to radiation-shielded containers and methods of assembly. More particularly, the invention relates to an improved composite-wall radiation-shielded cask and a method of a method of assembly which secures radiation-shielding material in non-annular sections to an inner shell, such as by straps or fasteners, to form a tightly bound inner assembly, with the bound inner assembly subsequently inserted into a larger outer shell, and a clearance gap between the outer shell and the inner assembly filled with a load bearing filler material.

### II. BACKGROUND OF THE INVENTION

Most composite-wall radiation-shielded casks use lead or depleted uranium (DU) for the primary shielding because they are very dense and have high atomic numbers. Current fabrication techniques used to make casks using these shielding materials are complex and difficult. The primary shield material is usually sandwiched between stainless steel inner and outer shells. Due to differences in physical properties and a complicated assembly process, it is difficult to get good contact between the radiation-shielding material and the stainless steel shells so that mechanical and thermal loads may be transferred between them.

In FIG. 1, a first representative prior art example of a composite-wall radiation-shielded cask is shown at reference character 100 having a multi-layer wall (i.e. composite-wall) construction surrounding a containment volume/cavity 101. The cask has a gamma shield 102 made from lead, and formed in a process involving pouring molten material between an inner wall 103 and an outer wall 104, and then allowing the sandwich assembly to cool down to room temperature. The process is complicated in that it must be performed in timed steps and carefully controlled to get the lead to bond against the inner and outer walls without distorting the same. In FIG. 1, the prior art cask is also shown having a neutron shield 105 surrounding the outer wall 104, a closure 106 at one end of the cask, and impact limiters 107 at both outer ends of the cask.

FIGS. 2A and 2B show a second representative prior art example of a composite-wall radiation-shielded cask generally indicated at reference character 200. In this example, the gamma shield is made from DU, and in particular by stacking DU sections 201-204 having notched annular ring configurations between the inner shell 206 and outer shell 207. Similar to the representative embodiment of FIG. 1, the construction/assembly process of stacking the DU rings is complicated. First, the rings are stacked around the inner shell 206 by cooling the stainless steel inner shell and heating each ring sufficiently to slide onto the inner shell. When this inner assembly comes to room temperature the DU must fit tight to the inner shell without distorting it. The second step is to cool down the assembly and heat up the outer shell 207 and slip the outer shell over the inner assembly. When the total assembly comes to room temperature the DU must fit tight to the inner and outer shells without distorting them. FIG. 2B shows a cross-sectional view of the cask 200, and illustrating the continuous annular ring structure of one of the sections (203) of the radiation-shielding positioned around the inner shell by the aforementioned process. FIG. 2B also shows a fuel basket 208 in the containment volume of the cask where spent nuclear fuel (SNF) 209 is stored. The assembly process requires machining to close tolerances the inner and outer surfaces of the DU. Machining of DU is very difficult and expensive because DU is a relatively hard, brittle, pyrophoric, radioactive material that must be fabricated in a vacuum or inert environment. Also there are special health concerns for the employees in handling and fabricating DU.

There is therefore a need for a simpler, more efficient and cost-effective method of constructing a radiation-shielded cask which overcomes the problems of the prior art described above.

### III. SUMMARY OF THE INVENTION

One aspect of the present invention includes a method of constructing a composite-wall radiation-shielded cask encompassing: providing an inner shell surrounding a containment volume; securing non-annular sections of a radiation-shielding material to the inner shell to form an inner assembly; inserting the inner assembly into an outer shell to form a clearance gap therebetween; and filling the clearance gap with filler material capable of transferring mechanical and thermal loads between the inner assembly and the outer shell.

Another aspect of the present invention includes a composite-wall radiation-shielded cask encompassing: an inner shell surrounding a containment volume; at least two non-annular sections of a radiation-shielding material; means for securing the non-annular sections of the radiation-shielding material to the inner shell to form an inner assembly; an outer shell surrounding the inner assembly to form a clearance gap therebetween; and filler material placed in the clearance gap and capable of transferring mechanical and thermal loads between the inner assembly and the outer shell.

### IV. BRIEF DESCRIPTION OF THE DRAWINGS

The accompanying drawings, which are incorporated into and form a part of the disclosure, are as follows:

FIG. 1 is a cross-sectional side view of a first composite-wall radiation-shielded cask representative of the prior art.

FIG. 2A is a cross-sectional side view of a second composite-wall radiation-shielded cask representative of the prior art.

FIG. 2B is a cross-sectional view of the second composite-wall radiation-shielded cask taken along line 2B-2B of FIG. 2A.

FIG. 3 is an exploded perspective view of a first exemplary embodiment of an inner assembly of the present invention.

FIG. 4 is a perspective view of the inner assembly of FIG. 3 shown assembled and bound.

FIG. 5A is a cross-sectional view taken along line 5A-5A of FIG. 4 showing a continuous annular band used for securing the sections of the radiation-shielding material.

FIG. 5B is a cross-sectional view similar to FIG. 5A showing an alternative adjustable strap used for securing the sections of the radiation-shielding material.

FIG. 6 is a perspective view of a second exemplary embodiment of an inner assembly of the present invention.

FIG. 7 is a cross-sectional view taken along the line 7-7 of FIG. 6.

FIG. 8 is a perspective view of an inner assembly being inserted into an outer shell.

FIG. 9 is a perspective view of the combined inner assembly and outer shell of FIG. 8, with filler material being added in the clearance gap.

FIG. 10 is a cross-sectional side view of a first exemplary embodiment of the composite-wall radiation-shielded cask of the present invention.

FIG. 11 is a cross-sectional view taken along the line 11-11 of FIG. 10.

FIG. 12 is a cross-sectional view of another exemplary embodiment of the composite-wall radiation-shielded cask of the present invention having a square cross-section.

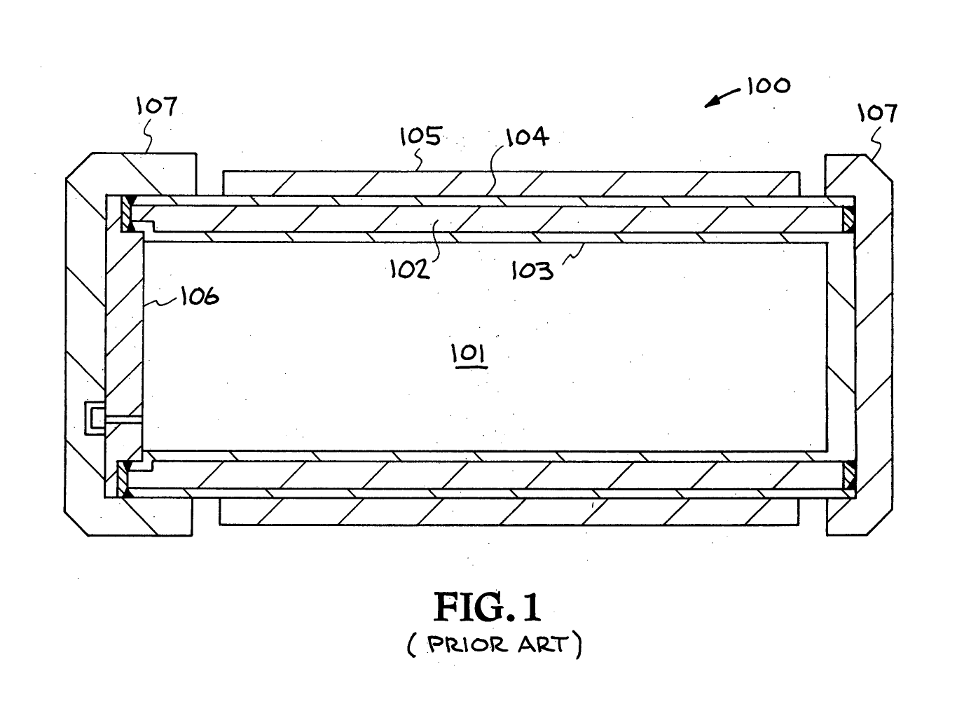

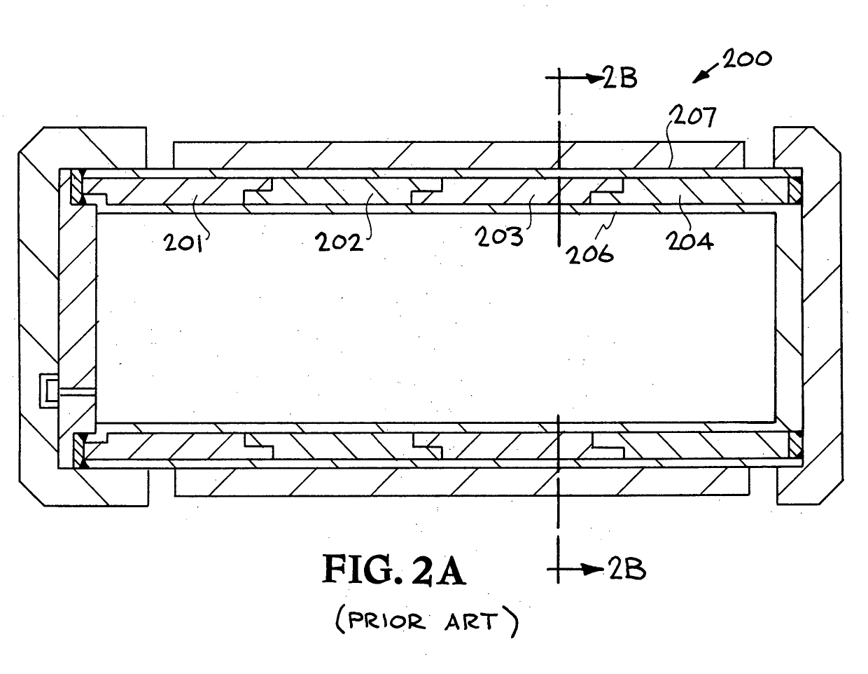

### V. DETAILED DESCRIPTION

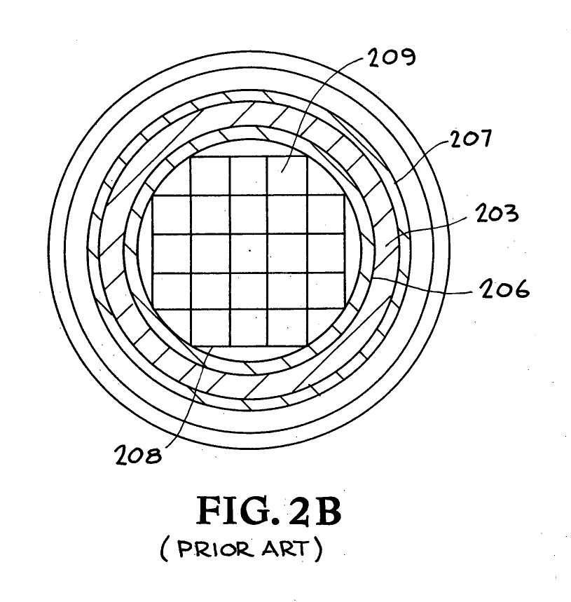

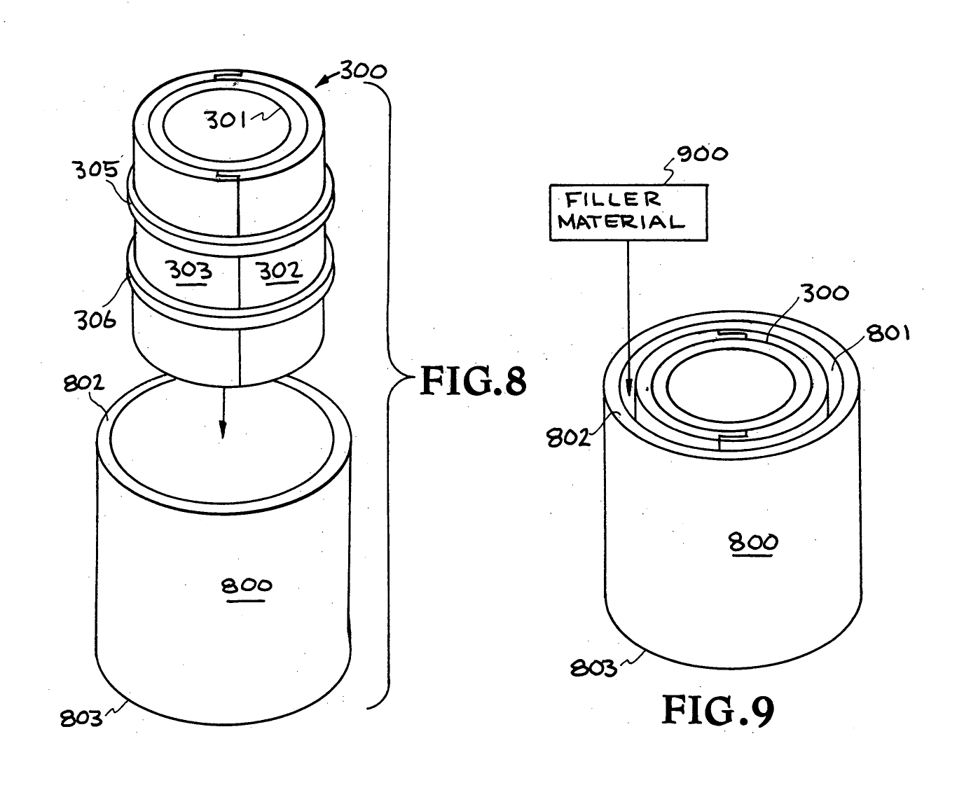

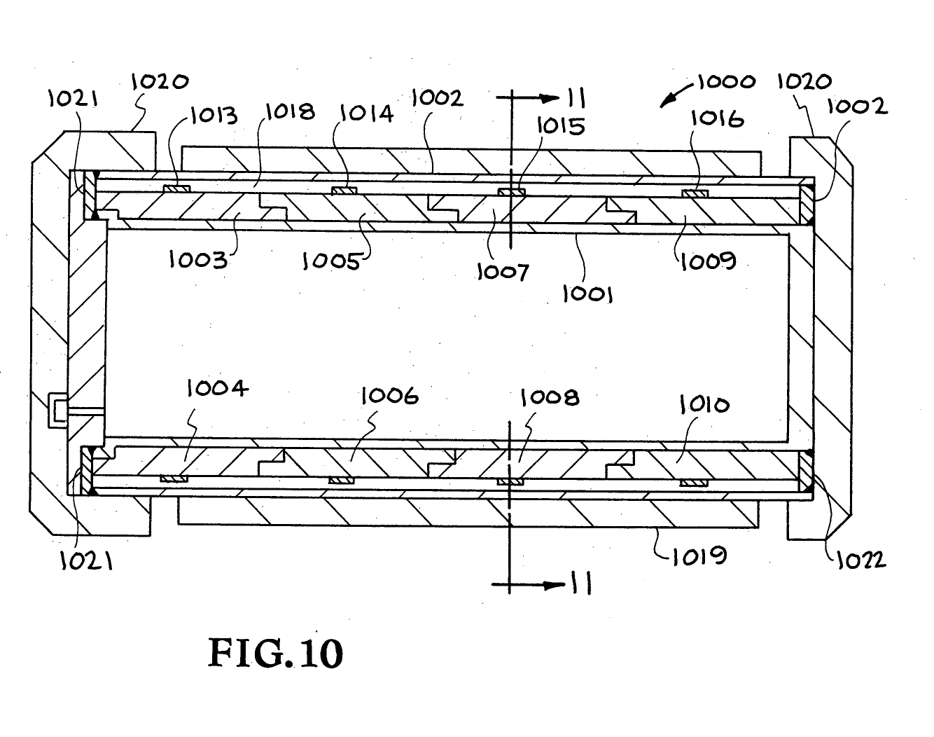

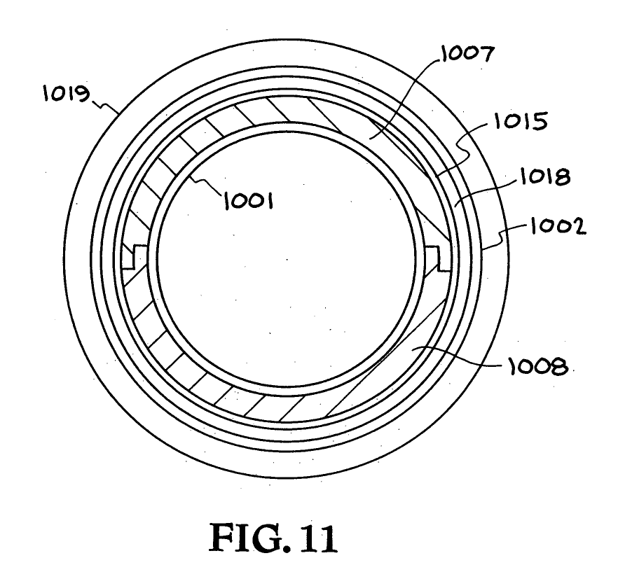

The present invention is directed to an improved composite-wall radiation-shielded cask and a method of assembling/constructing the same. Generally, the assembly process involves first assembling a bound inner assembly of the cask, such as shown in FIGS. 3-7. The bound inner assembly is formed using two or more non-annular sections of a radiation-shielding material which are secured to the outer surface of an inner containment shell using a strong banding material (i.e. strap) or fasteners. Subsequently, the bound inner assembly is inserted into an outer shell, shown in FIG. 8 to form a clearance gap between the inner assembly and the outer shell. The clearance gap is maintained, for example, by welding (not shown) the outer shell to the inner containment shell at a lower end. As shown in FIG. 9, the clearance gap is then filled through the open end (e.g. top end in FIG. 9) with a suitable filler material, such as a pourable hardening material, capable of transferring mechanical and thermal loads between the outer shell and the bound inner assembly. In this manner, both the constructed cask (e.g. shown in FIGS. 10 and 11) and the assembly thereof are greatly simplified without the need for complicated heating and cooling timed procedures and exacting control.

Turning now to the drawings, FIGS. 3-5 show a first exemplary embodiment of an inner assembly 300 of the composite-wall radiation-shielded cask of the present invention. The inner assembly is formed using an inner shell 301 surrounding a containment volume 301′ as the core component. The inner shell in FIGS. 3-5 is shown having a cylindrical configuration with a circular cross-section, but is not limited only to such. Other configurations of the inner shell may have cross-sections which are curvilinear or polygonal, such as the square cross-section shown in FIG. 12. In any case, the inner shell is shown having an open end 310 through which storage material may be introduced into the containment volume 30′, as well as a closed end 311 opposite the open end. And the inner shell is made of a structurally rigid material, such as for example stainless steel. Alternative material types suitable for the inner shell may include nickel or copper based alloys.

Surrounding the inner shell 301 is a primary radiation-shielding material, i.e. gamma radiation shield, made of a very dense high atomic number material, such as for example lead, uranium, or tungsten. In the alternative, other gamma-radiation-shielding materials may be utilized, including an iron-based material, such as cast iron or low alloy steel.

As shown in FIGS. 3-5 the primary radiation-shielding material has two non-annular, longitudinal half-sections 302 and 303. Each section is pre-formed to conform in shape to the inner shell and extends substantially the entire length of the inner shell to provide full shielding coverage. Additionally each half-section is shown having notches or offsets 304 for interconnecting with the other half-section, so as to reduce or prevent radiation streaming therethrough. Due to their non-annular pre-formed configurations, the sections may be placed directly against the inner shell, without having to either telescopically insert the inner shell through a tubular shield configuration, or mold a radiation-shield around the inner shell using a mold form, which facilitates assembly.

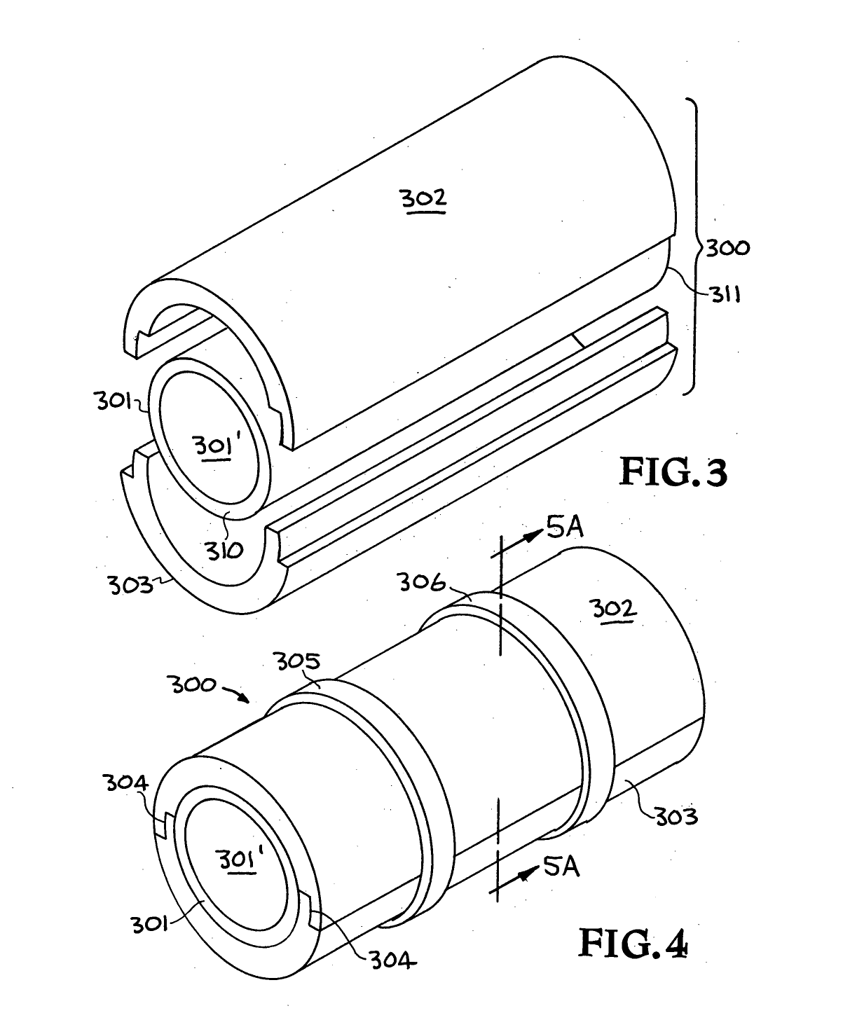

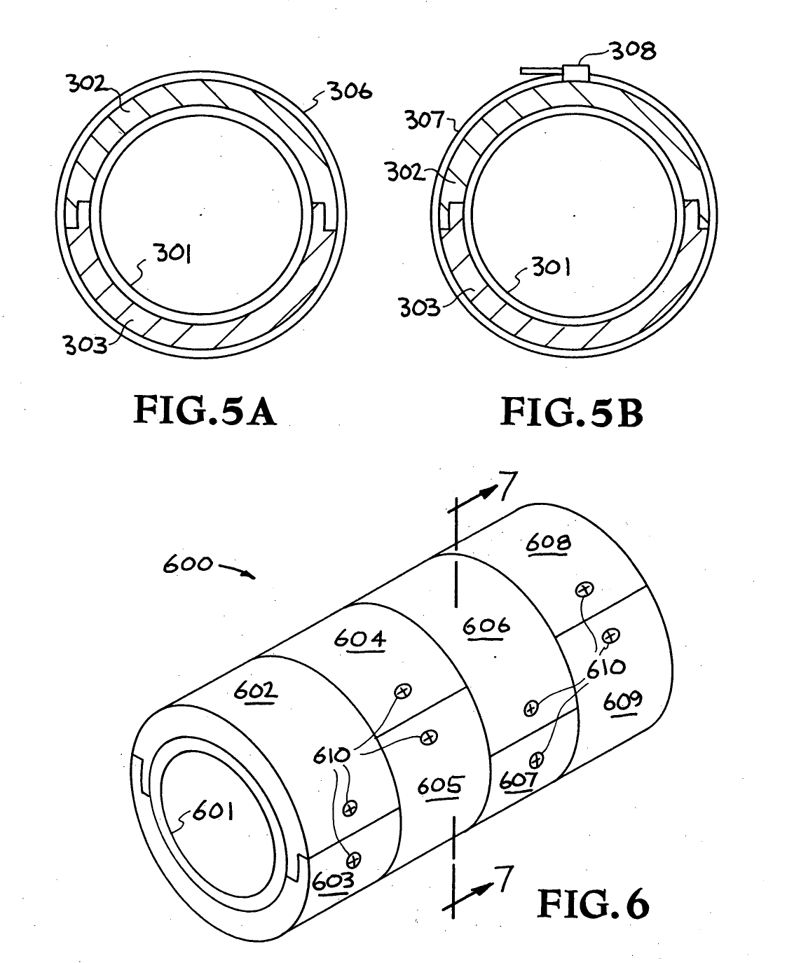

The non-annular sections of the primary radiation-shielding material are tightly secured to the inner shell 301 using a suitable securing method to produce an inner assembly. Various securing methods and devices known in the mechanical arts may be used for this purpose. One exemplary securing device shown in FIGS. 4, 5A and 5B is a banding material, i.e. strap, having sufficient strength to impart a constrictive force on the sections against the inner shell to produce a bound inner assembly. A pair of straps 305 and 36 is utilized in FIG. 4, although it is appreciated a single strap would also suffice for the two longitudinal half-sections 302 and 303. Thus one or more straps may be utilized depending on the number of sections provided to completely surround the inner shell. The straps are preferably made of a high strength material, such as high strength steel or a composite material, such as carbon or glass matrix. And as shown in FIG. 5A, the strap may be formed as a seamless unit ring construction upon being positioned to surround the sections, or as an adjustable strap 307, as shown in FIG. 5B, having a mechanism 308 known in the mechanical arts for reducing the circumference of the strap to tighten and constrict the strap around the sections.

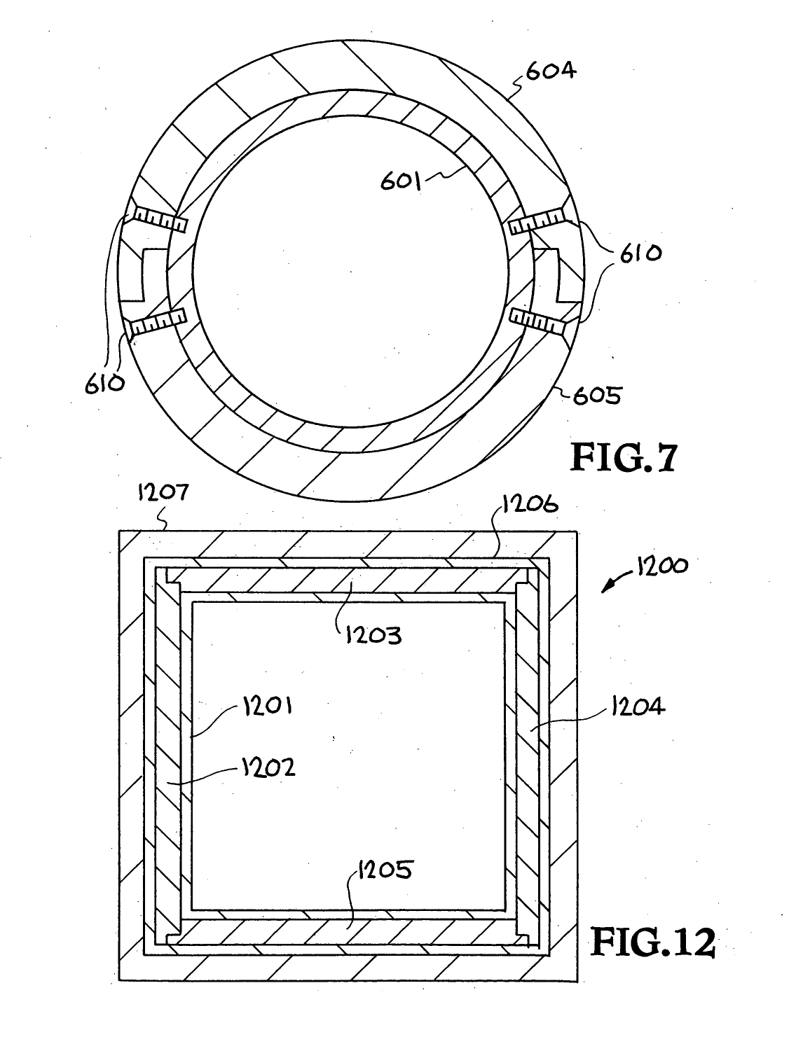

FIGS. 6 and 7 show a second exemplary embodiment of an inner assembly 600, having an inner shell 601 and a plurality of non-annular sections 602-609 of the primary radiation-shielding material. In particular, the plurality of non-annular sections is arranged in four sets, with each set having a split ring configuration surrounding the inner shell 601. And each section is secured to the inner shell 601 by means of fasteners, such as bolts 610. Similar to the straps discussed previously, the fasteners are also made from a high strength material, such as high strength steel or a composite material, such as carbon or glass matrix. FIG. 7 shows the bolt fasteners 610 securing opposite sides of the respective sections 604 and 605 to the inner shell 602. While not shown in the figures, it is appreciated that a screw-type fastener may also be used together with a strap to reduce the strap circumference to effect constriction.

FIGS. 8 and 9 show subsequent assembly steps upon initial construction of the inner assembly. As shown in FIG. 8, the tightly bound inner assembly 300 is inserted into an outer shell 800, shown having a cylindrical configuration with open ends, and preferably having the same or similar rigid material construction as the inner shell. The outer shell 800 has a greater diameter than the inner assembly 300 to facilitate insertion and assembly, and forms a clearance gap 801 between the outer shell 800 and the inner assembly 300. In order to maintain the clearance gap, the outer shell 800 may be welded or otherwise fixedly secured to the inner assembly 300 at one of the upper 802 or lower 803 open ends of the outer shell 800 to bridge and close off the clearance gap at that end.

In an alternative embodiment (not shown) where the outer shell has a similar configuration as the inner shell, i.e. having opposing open and closed ends, the inner assembly may be inserted into the outer shell such that the closed ends and open ends, respectively, of each shell are positioned adjacent the other. In this case, the clearance gap may be maintained by other suitable means known in the mechanical arts for maintaining central alignment of telescoping geometries to each other. One such example is an annular spacer (not shown) placed between the outer shell and the inner assembly.

As shown in FIG. 9, the clearance gap 801 is then filled through the open end, e.g. 802, with a suitable filler material 900 to make solid contact between the outer shell and the inner assembly to allow the efficient transfer of mechanical and thermal loads between them. The filler material is preferably selected from a metal material having high conducting and malleable properties, such as for example copper, lead or aluminum. Upon filling the gap with such a malleable filler material, the filler material may be tamped or crushed into the gap to ensure that no voids are present, and to provide rigid contact between the inner assembly and outer shell. In the alternative, a pourable hardening material may be used as the filler material, such as for example a cement or polymer. The filler material may also include a neutron poison material such as boron carbide, for reducing the neutron flux from the SNF. Next, the clearance gap is bridged at the open end and the outer shell fixedly secured to the inner assembly, such as by welding together the outer shell with the inner shell of the inner assembly.

FIGS. 10 and 11 together show an exemplary embodiment of a fully assembled composite-wall radiation-shielded cask, indicated at reference character 1000. The inner assembly includes an inner shell 1001 having non-annular sections 1003-1010 surrounding the inner shell in split-ring pairs. Each split-ring pair is secured to the inner shell by means of a corresponding one of straps 1013-1016 located along the length of the cask. An outer shell 1002 is radially spaced from the inner assembly, including the straps, with a filler material 1018 positioned and, in one embodiment, hardened in the clearance gap formed therebetween. Additionally, a neutron shield 1019 is shown also provided, as well as impact limiters 1020 on either end. The inner shell 1001 is shown fixedly secured to the outer shell 1002 at one end by welds 1021, and at the opposite end by welds 1022.

FIG. 12 shows a cross-sectional view of an alternative geometry of a cask 1200 of the present invention generally having a polygonal cross-section, and in particular a square cross-section. Four planar sections 1202-1205 of the primary radiation-shielding are joined at the corners to conform to the square cross-sectional shape of the inner shell 1201. And notches are also provided at the corners for interconnection between adjacent sections. A filler-filled gap 1206 separates the sections, including fasteners/straps (not shown), from the outer shell 1207 to produce a rigid cask structure.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

1. A method of constructing a composite-wall radiation-shielded cask comprising:
providing an inner shell surrounding a containment volume;
securing non-annular sections of a radiation-shielding material to said inner shell to form an inner assembly;
inserting said inner assembly into an outer shell to form a clearance gap therebetween; and
filling said clearance gap with filler material capable of transferring mechanical and thermal loads between said inner assembly and said outer shell.

2. The method of claim 1,
further comprising fixedly securing said outer shell to said inner assembly at one end thereof to maintain the clearance gap for the filling of said filler material.

3. The method of claim 2,
further comprising fixedly securing said outer shell to said inner assembly at the other end thereof after filling said clearance gap with said filler material.

4. The method of claim 1,
wherein fasteners are used to secure the non-annular sections of said radiation-shielding material to said inner shell.

5. The method of claim 4,
wherein the fasteners are made of a high strength metal.

6. The method of claim 4,
wherein the fasteners are made of a high strength composite.

7. The method of claim 1,
wherein at least one strap is used to band the non-annular sections of said radiation-shielding material to said inner shell to form a bound inner assembly.

8. The method of claim 7,
wherein the strap(s) is made of a high strength metal.

9. The method of claim 7,
wherein the strap(s) is made of a high strength composite.

10. The method of claim 1,
wherein said radiation-shielding material is a dense high atomic number material.

11. The method of claim 10,
wherein the dense high atomic number material is chosen from the group consisting of lead, uranium, and tungsten.

12. The method of claim 1,
wherein said radiation-shielding material is made from an iron-based material.

13. The method of claim 1,
wherein the non-annular sections of said radiation-shielding material conform in shape to said inner shell.

14. The method of claim 13,
wherein said inner shell has a curvilinear cross-section.

15. The method of claim 13,
wherein said inner shell has a polygonal cross-section.

16. The method of claim 1,
wherein the non-annular sections are notched to interconnect with adjacent non-annular sections.

17. The method of claim 1,
wherein said filler material is a highly-conductive malleable metal.

18. The method of claim 17,
wherein said filler material is chosen from the group consisting of copper, lead, and aluminum.

19. The method of claim 17,
further comprising tamping said filler material into said clearance gap to remove voids therein and provide rigid contact between said inner assembly and said outer shell.

20. The method of claim 1,
wherein said filler material is a pourable hardening material.

21. The method of claim 20,
wherein said filler material comprises a cement.

22. The method of claim 20,
wherein said filler material comprises a polymer.

23. The method of claim 1,
wherein said filler material comprises a neutron poison material.

24. The method of claim 23,
wherein the neutron poison material is boron carbide.

25. A composite-wall radiation-shielded cask produced according to the method of claim 1.

26. A composite-wall radiation-shielded cask comprising:
an inner shell surrounding a containment volume;
at least two non-annular sections of a radiation-shielding material;
means for securing the non-annular sections of said radiation-shielding material to said inner shell to form an inner assembly;
an outer shell surrounding said inner assembly to form a clearance gap therebetween; and
filler material placed in the clearance gap and capable of transferring mechanical and thermal loads between said inner assembly and said outer shell.

27. The composite-wall radiation-shielded cask of claim 26,
wherein said outer shell and said inner assembly each have opposing ends fixedly secured to an adjacent end of the other one of said outer shell and said inner assembly.

28. The composite-wall radiation-shielded cask of claim 26,
wherein fasteners are used to secure the non-annular sections of said radiation-shielding material to said inner shell.

29. The composite-wall radiation-shielded cask of claim 28,
wherein the fasteners are made of a high strength metal.

30. The composite-wall radiation-shielded cask of claim 28,
wherein the fasteners are made of a high strength composite.

31. The composite-wall radiation-shielded cask of claim 26,
wherein at least one strap(s) is used to band the non-annular sections of said radiation-shielding material to said inner shell to form a bound inner assembly.

32. The composite-wall radiation-shielded cask of claim 31,
wherein the strap(s) is made of a high strength metal.

33. The composite-wall radiation-shielded cask of claim 31,
wherein the strap(s) is made of a high strength composite.

34. The composite-wall radiation-shielded cask of claim 26,
wherein said radiation-shielding material is a dense high atomic number material.

35. The composite-wall radiation-shielded cask of claim 34,
wherein the dense high atomic number material is chosen from the group consisting of lead, uranium, and tungsten.

36. The composite-wall radiation-shielded cask of claim 26,
wherein said radiation-shielding material is made from an iron-based material.

37. The composite-wall radiation-shielded cask of claim 26,
wherein the sections of said radiation-shielding material conform in shape to said inner shell.

38. The composite-wall radiation-shielded cask of claim 37,
wherein said inner shell has a curvilinear cross-section.

39. The composite-wall radiation-shielded cask of claim 37,
wherein said inner shell has a polygonal cross-section.

40. The composite-wall radiation-shielded cask of claim 26,
wherein the non-annular sections are notched to interconnect with adjacent non-annular sections.

41. The composite-wall radiation-shielded cask of claim 26,
wherein said filler material is a highly conductive malleable metal.

42. The composite-wall radiation-shielded cask of claim 41,
wherein said filler material is selected from the group consisting of copper, lead, and aluminum.

43. The composite-wall radiation-shielded cask of claim 41,
wherein said highly conductive malleable material is tamped in said clearance gap to remove voids therein and provide rigid contact between said inner assembly and said outer shell.

44. The composite-wall radiation-shielded cask of claim 26,
wherein said filler material is a pourable hardening material.

45. The composite-wall radiation-shielded cask of claim 44,
wherein said filler material comprises a cement.

46. The composite-wall radiation-shielded cask of claim 44,
wherein said filler material comprises a polymer.

47. The composite-wall radiation-shielded cask of claim 26,
wherein said filler material comprises a neutron poison material.

48. The composite-wall radiation-shielded cask of claim 47,
wherein the neutron poison material is boron carbide.
